(19) United States
(12) Patent Application Publication
(10) Pub. No.: US 2012/0247149 A1
(43) Pub. Date: Oct. 4, 2012

(54) PROCESS COOLING SYSTEM AND METHOD USING SEAWATER

(75) Inventor: Stéphane Labelle, St-Jerome (CA)

(73) Assignee: EH2 (9170-3173) QUEBEC INC, Blainville, QC (CA)

(21) Appl. No.: 13/503,051

(22) PCT Filed: Oct. 20, 2010
(86) PCT No.: PCT/CA2010/001679

§ 371 Date: Jun. 13, 2012

Related U.S. Application Data
(60) Provisional application No. 61/297,645, filed on Jan. 22, 2010.
(60) Provisional application No. 61/314,204, filed on Mar. 16, 2010.
(60) Provisional application No. 61/323,905, filed on Apr. 14, 2010.

(30) Foreign Application Priority Data
Oct. 20, 2009 (CA) 2,682,782
Jan. 26, 2010 (CA) 2,691,140

(51) Int. Cl. B01D 9/04

(52) U.S. Cl. 62/544; 62/532

(57) ABSTRACT

A method for producing cold heat for cooling a process is provided. Seawater is pumped at a selected depth and cooled to create a mixture of ice and brine. The ice is separated from the brine. Cold heat is obtained by thawing the ice. A process cooling system for producing cold heat is also provided. A pumping station comprises a line system to obtain seawater and direct the seawater to an onshore cooling plant. A refrigerant circulates in an evaporation stage in a refrigeration circuit. A heat exchanger in the evaporation stage freezes a portion of the seawater in the line system with the refrigerant. A cooling plant is connected to the line system to receive the frozen seawater. The cooling plant comprises a separation tank for separating the frozen portion of seawater from brine, and a heat exchanger to cool the process by heat exchange with the frozen seawater.

### CROSS-REFERENCE TO RELATED APPLICATIONS

The present application claims priority on Canadian Patent Application No. 2,682,782, filed on Oct. 20, 2009, U.S. Provisional Patent Application No. 61/297,645, filed on Jan. 22, 2010, Canadian Patent Application No. 2,691,140, filed on Jan. 26, 2010, U.S. Provisional Patent Application No. 61/314,204, filed on Mar. 16, 2010, and U.S. Provisional Patent Application No. 61/323,905, filed on Apr. 14, 2010, all incorporated herein by reference.

### FIELD OF THE APPLICATION

The present application relates to a desalination method and system for providing cooling to a process and desalinated water.

### BACKGROUND OF THE ART

Traditionally, thermal power plants have been built near the ocean shore, enabling power-plant designers to use the large cooling potential available due to the ocean's thermal inertia. However, public concerns regarding the marine ecosystem have given way to new regulations in certain states, forcing thermal-plant and desalinating-plant administrators to reevaluate their cooling techniques; new approaches to the problem must be found.

In certain parts of the world, a secondary need exists simultaneously, that of providing fresh water in the region. Therefore, an interlinked system which could potentially answer both requirements simultaneously would become very interesting.

Water temperatures in the sea generally vary with depth. Water at the surface is heated by the sun and other climatic factors, and is therefore less dense and tends to remain at the surface. Colder, denser water is naturally found at greater depths. This phenomenon leads to natural temperature stratifications, otherwise known as thermoclines. It would be advantageous to raise this cold water to the surface in order to use it as a way to discard energy from processes located at the surface.

Another important aspect of stratification is the fact that as colder water is obtained with increasing depth in the ocean, the amount of oxygen in the water is decreased, decreasing the density of overall marine life. Combining this factor with current techniques and technologies will allow operators to minimize the impact of plant operations on marine life.

### SUMMARY OF THE APPLICATION

It is therefore an aim of the present disclosure to provide a process cooling system and method using seawater.

It is a further aim of the present disclosure that the process cooling system and method produce desalinated water.

Therefore, in accordance with a first embodiment of the present application, there is provided a method for producing cold heat for cooling a process comprising pumping seawater at a selected depth, cooling the seawater to create a mixture of ice and brine, separating the ice from the brine, and obtaining cold heat for the process by thawing the ice.

Further in accordance with the first embodiment, cooling the seawater comprises exposing the seawater to at least one evaporation stage of a refrigeration cycle in a heat-exchange relation.

Still further in accordance with the first embodiment, separating the ice from brine comprises separating the ice from brine by a gravity-type separation.

Still further in accordance with the first embodiment, cooling the seawater is performed offshore, and further comprising separating at least partially the ice from the brine, and conveying the ice to an onshore cooling plant prior to further separating the ice from the brine.

Still further in accordance with the first embodiment, conveying the ice to an onshore cooling plant comprises conveying the ice with cooled seawater.

Still further in accordance with the first embodiment, separating the ice from the brine at the onshore cooling plant comprises subjecting the ice and brine to a centrifugal treatment.

Still further in accordance with the first embodiment, obtaining cold heat for the process by thawing the ice comprises exposing the ice to at least one condensation stage of a Rankine cycle in a heat-exchange relation.

Still further in accordance with the first embodiment, exposing the ice to the Rankine cycle comprises exposing the ice to at least two condensation stages in series.

Still further in accordance with the first embodiment, the thawed ice is used as desalinated water after cooling the process.

Still further in accordance with the first embodiment, the ice is conveyed remotely from the cooling plant to the distally located process.

Still further in accordance with the first embodiment, the brine is rejected from the separations to the sea.

In accordance with a second embodiment of the present application, there is provided a process cooling system for producing cold heat to cool a process, comprising: a pumping station comprising a line system for obtaining seawater at a selected depth and for directing the seawater to an onshore cooling plant, a refrigeration circuit with a refrigeration cycle in which a refrigerant circulates in an evaporation stage, and at least a first heat exchanger in said evaporation stage to freeze a portion of the seawater in the line system with the refrigerant; and a cooling plant connected to the line system to receive the frozen portion of seawater, the cooling plant comprising at least a first separation tank for further separating the frozen portion of seawater from brine, and at least a second heat exchanger to cool the process by heat exchange with the frozen portion of seawater.

Further in accordance with the second embodiment, the refrigeration circuit has a condensation stage with another heat exchanger in which the refrigerant is in heat exchange with at least one of seawater, and brine exiting from the first separation tank.

Still further in accordance with the second embodiment, a melting tank downstream of the separation tank further mixes the frozen portion of seawater with freshwater for feeding water to the second heat exchanger.

Still further in accordance with the second embodiment, an insulated line system between the first separation tank and the second heat exchanger conveys the cold heat distally from the onshore cooling plant.

Still further in accordance with the second embodiment, the pumping station is located offshore, and further comprising at least a second separation tank for separating at least partially the frozen portion of seawater from brine.

Still further in accordance with the second embodiment, at least a second heat exchanger in the pumping station cools another portion of seawater in the line system, the other portion of seawater being used to convey the frozen portion of seawater to the onshore cooling plant.

Still further in accordance with the second embodiment, the other portion of seawater is mixed with the frozen portion of seawater downstream of the second separation tank.

Still further in accordance with the second embodiment, the process is a Rankine cycle, with the second heat exchanger being in a condensation stage of the Rankine cycle.

### BRIEF DESCRIPTION OF THE DRAWINGS

FIG. 1 is a schematic view of a process cooling system using seawater in accordance with the present disclosure.

FIG. 2 is a block diagram showing a pumping station of the process cooling system of FIG. 1;

FIG. 3 is a block diagram of a cooling plant of the process cooling system of FIG. 1, with intermediate Rankine circuit;

FIG. 4 is a block diagram of a cooling plant of the process cooling system of FIG. 1, with direct cooling; and

FIG. 5 is a block diagram showing a pumping station of the process cooling system, without brine separation.

### DESCRIPTION OF THE PREFERRED EMBODIMENTS

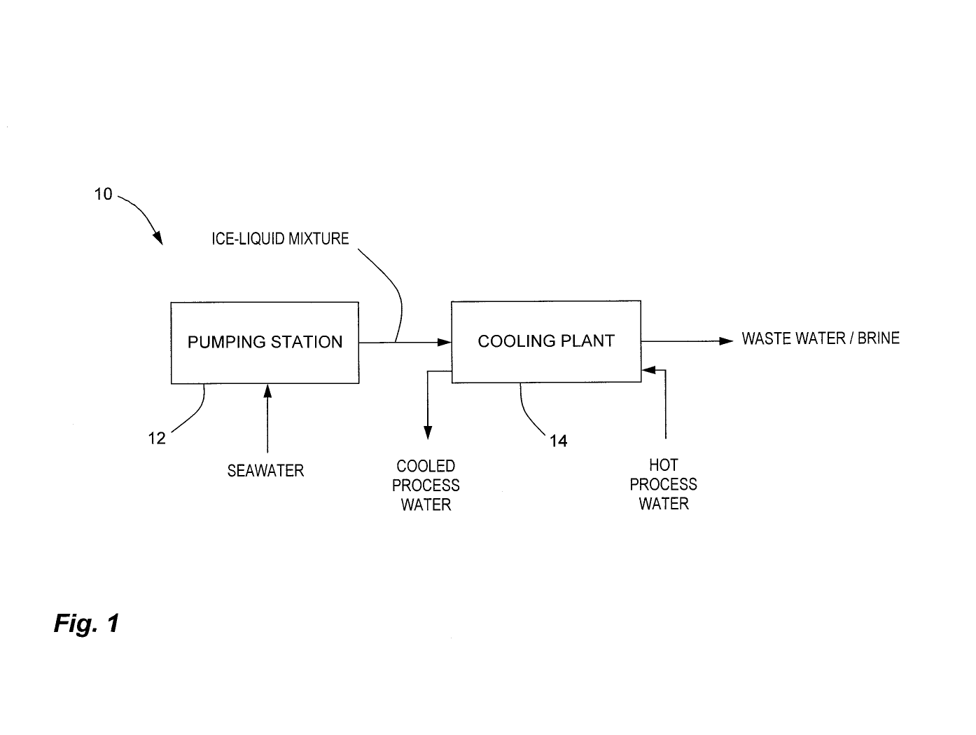

Referring to the drawings, and more particularly to FIG. 1, there is illustrated at 10 a process cooling system using seawater. The process cooling system 10 using seawater has a pumping station pumping seawater at selected depth. The pumping station 12 may be on the coast, or away from the coast. For instance, it is considered to pump seawater from colder layers, such as the mesopelagic aquatic layer (200-1000 meters), or the bathypelagic aquatic layer (1000-4000 meters), which layers may be at a substantial distance from the coast, or relatively nearby in specific geographical locations. The seawater pumped and treated by the pumping station 12 is directed to a cooling plant 14 onshore, such as a thermal power plant or any plant having cooling requirements for any given process. The cooled seawater is used to a cool process liquid or solid, for instance by the use of a refrigerant, while being desalinated. According to an embodiment, the pumping station 12 and the cooling plant 14 combine to define a freeze-desalination system. The desalination is performed partly on the pumping station with the freezing steps and gravity separation performed thereat. The centrifugal separation of ice from brine may be performed at the pumping station 12 or at the cooling plant 14. The thawing of the ice is used to cool a process refrigerant, as described hereinafter.

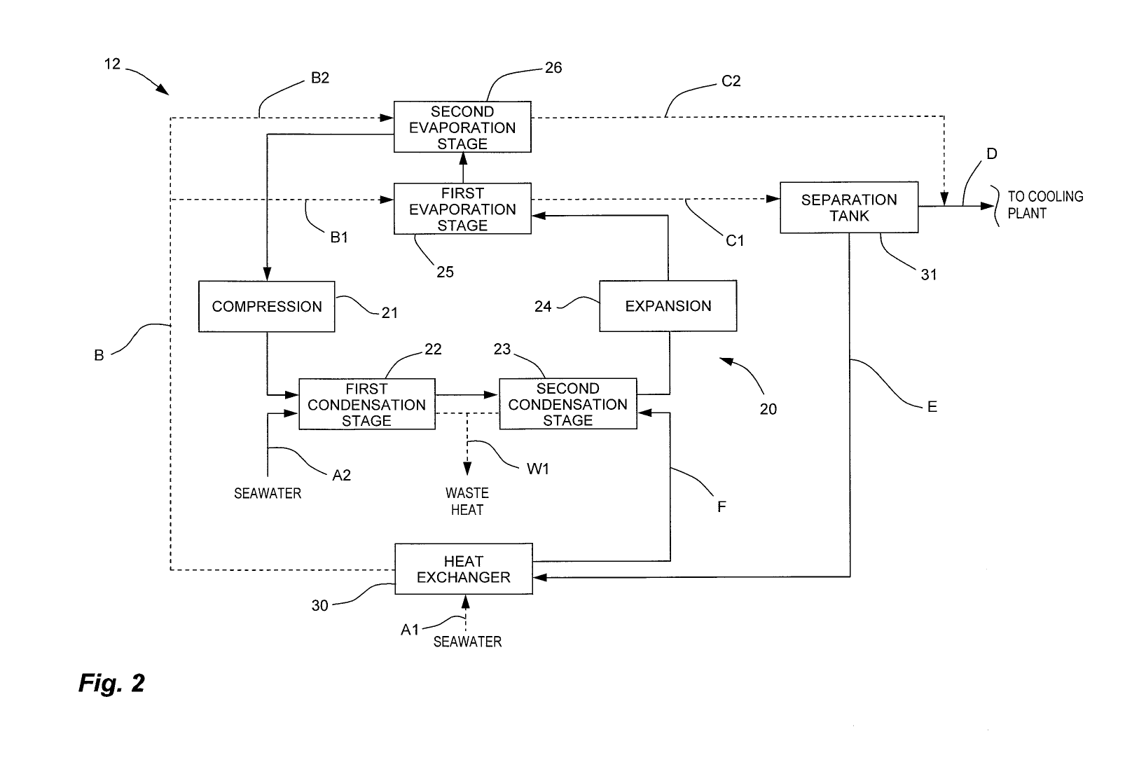

Referring to FIG. 2, the pumping station 12 is shown in greater detail. The pumping station 12 may be for instance a floating station (or bottom-supported) located offshore to pump seawater at depths as set forth above, or may be mostly onshore, near the cooling plant 14. The pumping station 12 features a conventional refrigeration circuit 20. The refrigeration circuit 20 is a closed circuit in which a refrigerant circulates through the various stages of refrigeration. More specifically, the refrigeration circuit 20 has a compression stage 21 in which the refrigerant is compressed to a high-pressure-gas state.

Condensation in the refrigeration circuit 20 is performed by a serial sequence of a first condensation stage 22 and a second condensation stage 23, although the stages 22 and 23 could also be in series. The condensation stages 22 and 23 are used to release heat from the refrigerant circulating in the refrigeration circuit 20. The refrigerant is generally in a liquid state at the exit of the condensation stages 22 and 23 and is sent to an expansion stage 24 in which the refrigerant is expanded to a low-pressure gaseous state.

The evaporation in the refrigeration circuit is performed by the first evaporation stage 25 and the second evaporation stage 26 serially positioned with respect to one another, although other arrangements are considered as well. The evaporation stages 25 and 26 absorb heat, as will be described hereinafter. The refrigerant exiting the evaporation stage is returned to the compression stage 21 to close the refrigeration circuit 20.

Although the condensation stages 22 and 23 and the evaporation stages 25 and 26 are shown in serial relation, these stages may be parallel as well, or in any other suitable arrangement. Any suitable refrigerant may be used in the refrigeration circuit 20, such as standard synthetic refrigerants, ammonia, butane, alcohol-based refrigerants, carbon dioxide or the like.

Still referring to FIG. 2, seawater is pumped from the sea, at depths. The seawater temperature is typically about 5° C. (e.g., between 2° C. and 8° C.), and is pumped through pipe or pipes A1. The seawater passing through pipe A1 may go through a heat exchanger 30, in which the seawater is cooled. The liquid absorbing heat from the seawater in the heat exchanger 30 is brine exiting from the pumping station 12.

The seawater cooled in the heat exchanger 30 is directed to the first and second evaporation stages 25 and 26 via line B splitting into line B1, going to the first evaporation stage 25, and in the set-up where an offshore station is used to provide the ice-brine mix, line B2 is directed to the second evaporation stage 26. Accordingly, the seawater is in a heat-exchange relation with the refrigerant circulating in the refrigeration circuit 20.

In the embodiment in which the ice-brine mixture is created on an offshore station, line B1 enters the first evaporation stage 25 and exits as line C1. The seawater reaching C1 is an ice-brine mixture of relatively low temperature (e.g., −1.8° C. to −5.0° C.). The ice-brine mixture is directed to a separation tank 31.

In the embodiment in which the ice-brine mixture is created on an offshore station, the separation tank 31 is a gravity-type separating unit, that partially separates the brine from the ice. More specifically, the ice will have a tendency to be at the surface, while the brine will go to the bottom of the tank 31. Accordingly, a major portion of the ice with water (the ice and water at a lower salinity than upstream of the tank 31) is directed toward the cooling plant 14 onshore through pipe D, whereas a portion of the brine will be directed to the heat exchange 30 via pipe E.

In the embodiment in which the ice-brine mixture is created on an offshore station, line C2 exits the second evaporation stage 26, in which the seawater is in heat exchange with the refrigerant of the refrigeration circuit 20, and is mixed with the ice exiting the separation tank 31, and will serve as conveying medium to transport the ice to the cooling plant 14. The seawater in pipe C2 is at about the same temperature as the ice exiting the separation tank 31, and will thus combine with the ice without substantially melting it during transportation of the ice toward the cooling plant 14. Pipe D is typically an insulated pipe. The insulated pipe D may be on the sea floor, at a suitable depth, in ground, etc. For instance, the insulated pipe D may be connected to existing pipe structures/networks to benefit from existing structures.

The brine sent to the heat exchanger 30 is then directed to the second condensation stage 23 via pipe F. Accordingly, the brine absorbs heat from the second condensation stage 23. Resulting waste heat W1 is rejected to the sea. However, considering that the brine has gone through one of the evaporation stages, its temperature is relatively low. The first condensation stage 22 uses the seawater in line A2, also to reject waste heat in the sea via pipe W1 or any other separate pipe. The waste brine exiting in W1 is in suitable condition to either be sent to act as a coolant in other units of the power plant, or to be directly returned to the ocean close to shore at a temperature which is near the temperature of the ocean water in which it is rejected, further minimizing impacts to the marine ecosystem.

Although not shown in FIG. 2, appropriate valves and pumps are provided in the various circuits and lines to ensure the operation of the station 12 as described above.

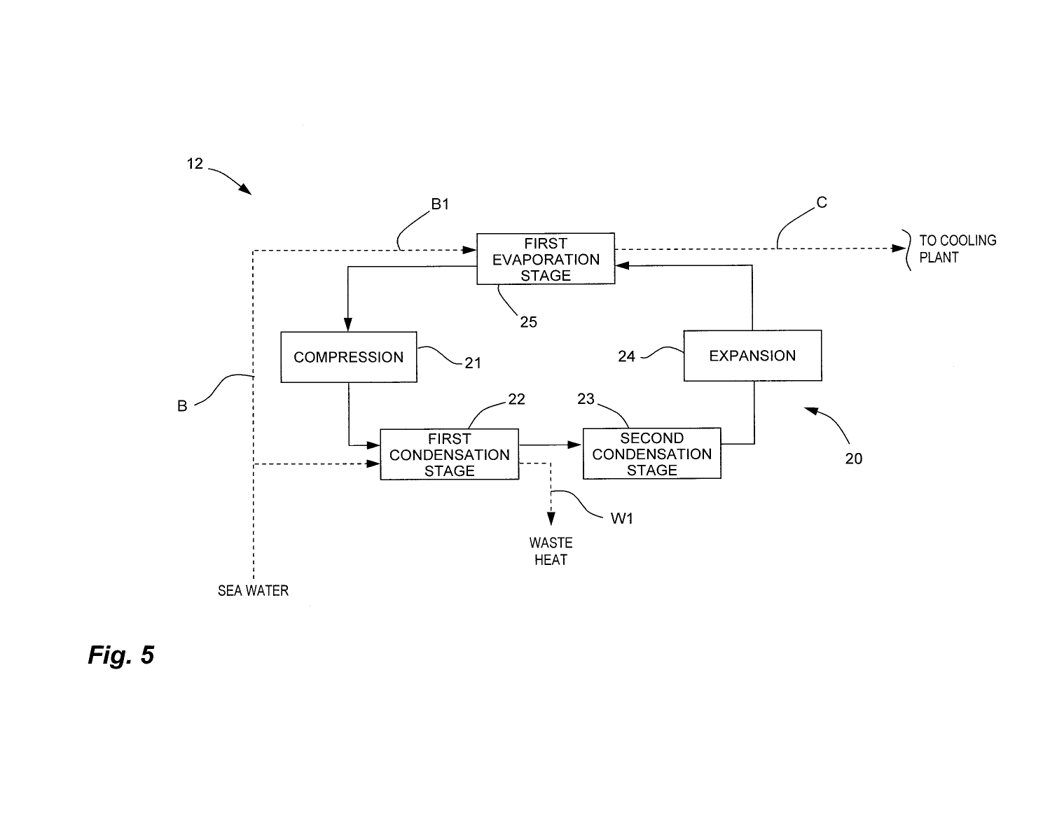

Referring to FIG. 5, another embodiment of the pumping station 12 is illustrated. In the embodiment of FIG. 5, the pumping station 12 does not perform any ice/brine separation, and therefore does not have any separation tank 31. Accordingly, in the embodiment of FIG. 5, seawater is cooled by the first evaporation stage 25, such that the a mixture of ice and brine is obtained. This mixture may be sent directly to the cooling plant 14, in which the ice/brine separation will be performed.

The pumping station 12 as embodied in FIG. 5 features fewer components. Therefore, for offshore applications, the pumping station 12 of FIG. 5 may prove to be a more cost-efficient solution.

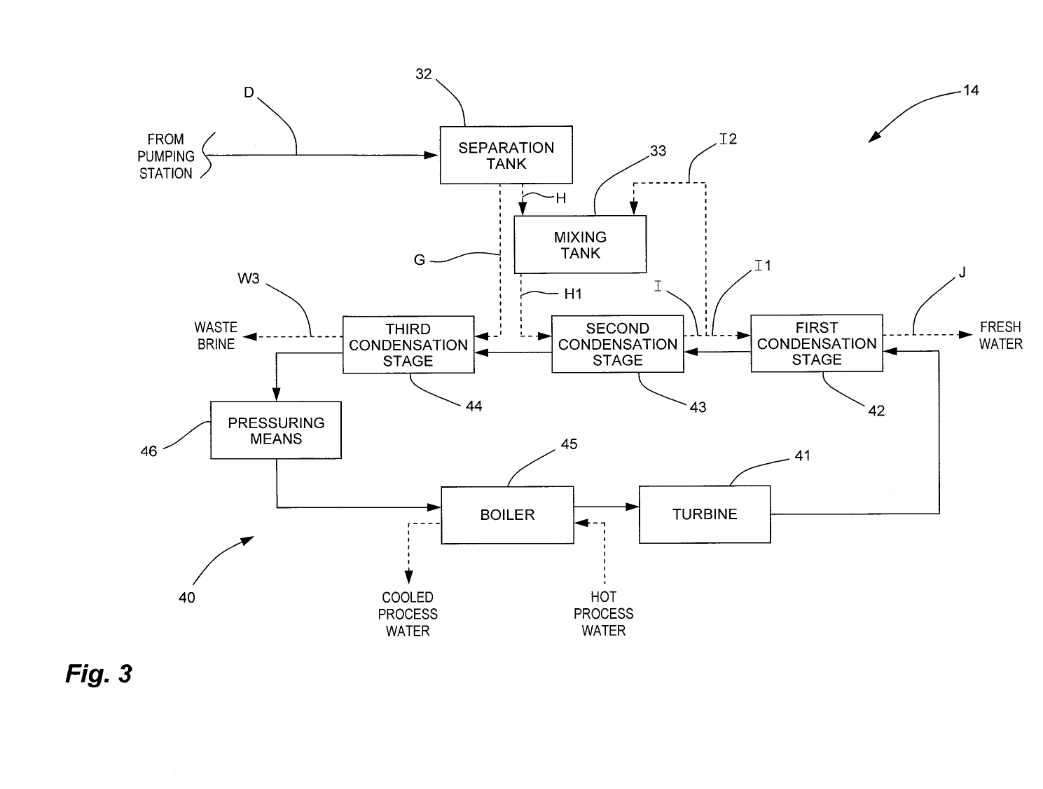

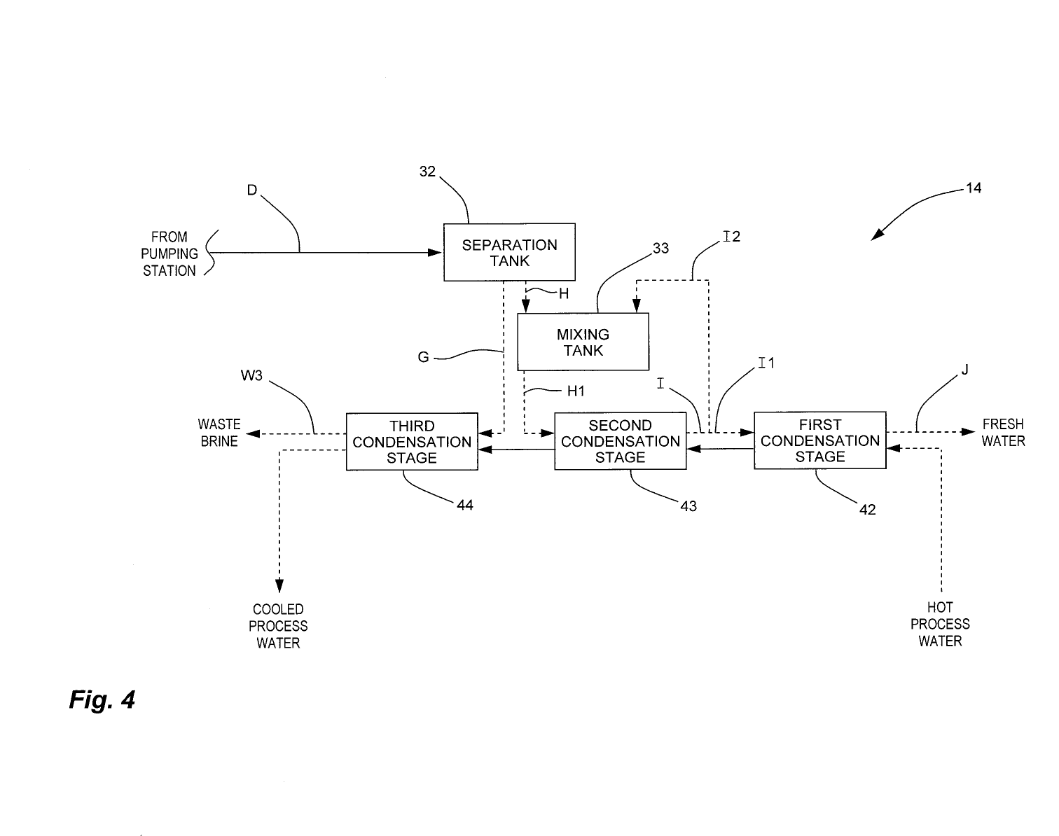

Referring to FIG. 3, the ice-brine mixture circulates through the pipe D and appropriate pumps all the way to the cooling plant 14 that is on shore. The ice-brine mixture is received in a separation tank 32. The ice portion of the separation tank 32 exits the separation tank 32 via pipe H to reach a mixing tank 33, whereas the brine exits through pipe G, and combines with fresh water, as described later. Although not illustrated, the separation tank 32 may be of the type using gravity to separate brine from ice. The separation tank 32 may be the centrifugal component of a freeze-desalination system, as combined with the separation tank 31 and the action of the evaporator stage 25 of the refrigeration circuit 20, both of the pumping station 12. If the pumping station 12 is on shore, only one of the separation tanks 31 and 32 may be required. The mixing tank 33 mixes the ice exiting from the separation tank 32 with water, in view of the subsequent heat exchange with the condensation stage 43. Both pipes H1 and G are in heat-exchange relation with a process refrigeration circuit 40 (e.g., operating a Rankine cycle), namely an intermediate circuit between the seawater circuit and the process. As described subsequently in FIG. 4, the process cooling system 10 may be operated without such intermediate circuit. The process refrigeration circuit 40 has a turbine 41, in which a refrigerant is decompressed. The refrigerant then circulates through the condensation stage. In the embodiment of FIG. 1, the condensation features first condensation stage 42, second condensation stage 43 and third condensation stage 44, serially positioned with respect to one another. In the three condensation stages, heat is absorbed from the refrigerant circulating in the closed circuitry of the refrigeration circuit 40. The cooled refrigerant is pumped to a higher pressure (for instance by pump 46) then reaches the boiler 45, in which the refrigeration circuit 40 absorbs heat from the process, whereby hot process liquid is cooled and exits as a cooled process liquid. Although not shown, other stages may be present in the circuit 40, such as expansion stages. Any suitable type of refrigerant may be used in the process refrigeration circuit 40. For instance, refrigerants such as butane (if all necessary precautions are taken) and refrigerants R-123, R-245fa may be used among many other types of refrigerants.

The ice exiting the separation tank 32 via pipe H is mixed with fresh water from pipe I2. The mixture is then in heat exchange with the refrigerant of the second condensation stage 43, so as to absorb heat, and melt at least partially. The water exiting the second condensation stage 43 is then split into pipes I1 and I2. The ice exiting the separation tank 32 may be melted prior to being fed to the second condensation stage 43. For instance, a mixing tank 33 may be used to mix fresh water from pipe I2 with the ice. Accordingly, melting the ice in the mixing tank 33 subsequently facilitates its heat exchange with the second condensation stage 43 via pipe H1. The mixing tank 33 may use any appropriate type of system, such as a separation tank similar to the tank 31, a gravity-type separating unit, or the like. The water passing through I1 is sent to the first condensation stage 42 to further cool the refrigerant circulating in the refrigeration circuit 40, to result in water in a relatively cold state with a relatively low salinity. Therefore, in that state, the water may in some circumstances be rejected to the sea or used as fresh water for nearby demand (e.g., local applications, markets).

The pipe I2 returns water to pipe H or at the separation tank 32 to carry ice that has been separated from the brine in tank 32. Accordingly, the liquid from I2 forms a conveying medium for the ice component of the separation tank 32. The resulting mixture of ice and water can be carried through pipe H1, insulated to allow the mixture to travel long distances to transport the sink from the ocean to other power plans, to cool buildings or optimize the efficiency of any industrial processes.

The brine exiting the separation tank 32 is also in a relatively cold state and is thus circulated through the third condensation state 44, in which it will be in heat-exchange relation with the refrigerant circulating through the refrigeration circuit 40. The waste brine exiting in W3 is in suitable condition to either be sent to act as a coolant in other units of the power plant, or to be directly returned to the ocean close to shore at a temperature which is near the temperature of the ocean water in which it is rejected, further minimizing impacts to the marine ecosystem.

Referring to FIG. 4, the cooling plant 14 is shown without any intermediate refrigeration circuit. Therefore, the condensation stages 42, 43 and 44 are in direct heat exchange relation with the process. For instance, a liquid of the process may pass through the condensation stages 42, 43 and 44 to release heat.

In another embodiment, the mix of ice and water or cold water coming from the pipe H1 may be used to cool photovoltaic cells of solar panels. It is known that such photovoltaic cells operate optimally under specific conditions, whereby it may necessary to cool the cells. The condensation stages 42, 43 and/or 44 may be used for this purpose, whether the cells are in close proximity to the condensation stages 42, 43 and/or 44, or remotely located. In the latter case, a cooling circuit may be used to gap the distance.

In the embodiment in which the process cooling system 10 is used in conjunction with a power plant, another way of producing electricity and using the freeze desalination of seawater is to branch off from deep water pipe A1, which directly provides cold seawater to the power plants' condensers. Part of the seawater is sent to the freeze desalination process via pipe B1, which relies on part of the surplus energy created by using the colder water in the power plants' condenser (boiler) 45. The resulting ice, once separated into a fresh ice/water mix by separation tank 32, is used to improve the efficiency of the system in a third freeze desalination condenser in series with condensers and 23, causing the overall system to require less energy for desalination. Alternatively, as the fresh water J exiting the cooling plant 14 is cold, it may be used to cool the photovoltaic cells of solar panels. As the water cools the photovoltaic cells, the thermal energy transferred to the water will bring the temperature of the water high enough to produce more hot water to feed the first condensation stage 42.

1.-19. (canceled)

20. A method for producing cold heat for cooling a process comprising:
pumping seawater at a selected depth;
cooling the seawater to create a mixture of ice and brine;
separating the ice from the brine; and
obtaining cold heat for the process by thawing the ice.

21. The method according to claim 20, wherein cooling the seawater comprises exposing the seawater to at least one evaporation stage of a refrigeration cycle in a heat-exchange relation.

22. The method according to claim 20, wherein separating the ice from brine comprises separating the ice from brine by a gravity-type separation.

23. The method according to claim 20, wherein cooling the seawater is performed offshore, and further comprising separating at least partially the ice from the brine; and
conveying the ice to an onshore cooling plant prior to further separating the ice from the brine.

24. The method according to claim 23, wherein conveying the ice to an onshore cooling plant comprises conveying the ice with cooled seawater.

25. The method according to claim 20, wherein separating the ice from the brine at the onshore cooling plant comprises subjecting the ice and brine to a centrifugal treatment.

26. The method according to claim 20, wherein obtaining cold heat for the process by thawing the ice comprises exposing the ice to at least one condensation stage of a Rankine cycle in a heat-exchange relation.

27. The method according to claim 26, wherein exposing the ice to the Rankine cycle comprises exposing the ice to at least two condensation stages in series.

28. The method according to claim 20, further comprising using the thawed ice as desalinated water after cooling the process.

29. The method according to claim 20, further comprising conveying the ice remotely from the cooling plant to the distally located process.

30. The method according to claim 20, further comprising rejecting the brine from the separations to the sea.

31. A process cooling system for producing cold heat to cool a process, comprising:
a pumping station comprising:
a line system for obtaining seawater at a selected depth and for directing the seawater to an onshore cooling plant,
a refrigeration circuit with a refrigeration cycle in which a refrigerant circulates in an evaporation stage, and
at least a first heat exchanger in said evaporation stage to freeze a portion of the seawater in the line system with the refrigerant; and
a cooling plant connected to the line system to receive the frozen portion of seawater, the cooling plant comprising:
at least a first separation tank for further separating the frozen portion of seawater from brine, and
at least a second heat exchanger to cool the process by heat exchange with the frozen portion of seawater.

32. The process cooling system according to claim 31, wherein the refrigeration circuit has a condensation stage with another heat exchanger in which the refrigerant is in heat exchange with at least one of seawater, and brine exiting from the first separation tank.

33. The process cooling system according to claim 31, further comprising a mixing tank downstream of the separation tank for further mixing the frozen portion of seawater with freshwater exiting from the second heat exchanger for feeding water to the second heat exchanger.

34. The process cooling system according to claim 31, further comprising an insulated line system between the first separation tank and the second heat exchanger, for conveying the cold heat distally from the onshore cooling plant.

35. The process cooling system according to claim 31, wherein the pumping station is located offshore, and further comprising at least a second separation tank for separating at least partially the frozen portion of seawater from brine.

36. The process cooling system according to claim 35, further comprising at least a second heat exchanger in the pumping station to cool another portion of seawater in the line system, the other portion of seawater being used to convey the frozen portion of seawater to the onshore cooling plant.

37. The process cooling system according to claim 36, wherein the other portion of seawater is mixed with the frozen portion of seawater downstream of the second separation tank.

38. The process cooling system according to claim 31, wherein the process is a Rankine cycle, with the second heat exchanger being in a condensation stage of the Rankine cycle.
